(19) United States
(12) Patent Application Publication
(10) Pub. No.: US 2016/0048342 A1
(43) Pub. Date: Feb. 18, 2016

(54) REDUCING READ/WRITE OVERHEAD IN A STORAGE ARRAY

(71) Applicant: Facebook, Inc., Menlo Park, CA (US)

(72) Inventors: Hongzhong Jia, Cupertino, CA (US); Narsing Vijayrao, Santa Clara, CA (US); Jason Taylor, Berkeley, CA (US)

(21) Appl. No.: 14/457,890

(22) Filed: Aug. 12, 2014

(51) Int. Cl. G06F 3/06

(52) U.S. Cl. CPC G06F 3/0611; G06F 3/0644; G06F 3/0689

(57) ABSTRACT

Techniques, systems, and devices are disclosed for reducing data read/write overhead in a storage array, such as a redundant array of independent disks (RAID), by dynamically configuring stripe sizes in disk drives. In one aspect, each disk drive is configured with multiple stripe sizes based on statistical file sizes of incoming data traffic. For example, a preconfigured disk drive can include a set of different stripe sizes wherein a stripe size is consistent with the size of a common file type in the historical or predicted data traffic. Moreover, the allocation of disk space for each stripe size may be consistent with the composition percentage of the associated file type in the historical or predicted data traffic. As a result, reads/writes of large data files in the storage array predominantly take place on a single disk drive rather than on multiple drives, thereby reducing read/write overheads.

### TECHNICAL FIELD

The disclosed embodiments are directed to reducing data read/write overhead in a storage array, such as a redundant array of independent disks (RAID).

### BACKGROUND

Driven by the explosive growth of social media and demand for social networking services, computer systems continue to evolve and become increasingly more powerful in order to process larger volumes of data and to execute larger and more sophisticated computer programs. To accommodate these larger volumes of data and larger programs, computer systems are using increasingly higher capacity drives (e.g., hard disk drives (HDD or “disk drives”), flash drives, and optical media) as well as larger numbers of drives, typically organized into drive arrays, e.g., redundant arrays of independent disks (RAID). For example, some storage systems currently support more than thousands of drives. Meanwhile, the storage capacity of a single drive has surpassed several Terabytes.

In disk-array systems, a data striping technique can be used when committing large files to a disk array. To enable data striping, each drive in the disk array is typically partitioned into equal-size stripes. Next, to write a large file, a data striping technique divides the large file into multiple segments of the predetermined stripe size, and then spreads the segments across multiple drives, for example, by writing each segment into a data stripe of a different disk. When reading back a segmented file, multiple reads are performed across the multiple drives storing the multiple segments. Because writing or reading of a segmented file takes place across multiple drives in parallel, the data striping technique significantly improves data channel performance and throughput.

In RAID systems, arrays employ two or more drives in combination to provide data redundancy, so that data loss due to a drive failure can be recovered from associated drives. When a RAID system employs a data striping scheme, a segmented file can be written into a set of data stripes on multiple drives. To mitigate the loss of data caused by drive failures, parity data are computed based on the multiple stripes of data stored on the multiple drives. The parity data are then stored on a separate drive for reconstructing the segmented file if one of the drives containing the segmented file fails. However, when a segmented file is updated, updating the associated parity data requires that all drives that contain data stripes of the segmented file be read so as to recomputed the parity data. Consequently, when there are a large number of segmented files and many updates to these files, the overhead resulting from parity data updates can consume a significant amount of system bandwidth. This parity update overhead is in addition to the overhead associated with reading multiple drives during regular read accesses of the segmented large files.

### BRIEF DESCRIPTION OF DRAWINGS

FIG. 1 is a schematic diagram illustrating a storage array system, such as a RAID.

FIG. 2 is an illustration of a scheme of dynamic data striping on a set of drives of a RAID system.

FIG. 3 is a flowchart illustrating a process of configuring a disk drive array for data striping.

FIG. 4 is a flowchart illustrating a process of executing a file write request on a preconfigured disk drive resulting from the process of FIG. 3.

### DETAILED DESCRIPTION

Disclosed are techniques, systems, and devices for reducing data read/write overhead in a storage array, such as a RAID, by dynamically configuring stripe sizes in disk drives. Existing storage array systems use a constant stripe size to segment all the disk drives in the array. This means a large data file is often broken up and stored on multiple drives, thereby requiring multiple reads/writes for reading/writing such a file, as well as overhead associated with reading parity data on multiple drives. In some embodiments, each disk drive is configured with multiple stripe sizes based on statistical file sizes of incoming data traffic. For example, a preconfigured disk drive can include a set of different stripe sizes wherein a stripe size is consistent with the size of a common file type in the historical or predicted data traffic. Moreover, the allocation of disk space for each stripe size may be consistent with the composition percentage of the associated file type in the historical or predicted data traffic. As a result, reads/writes of large data files in the storage array are more likely to occur on a single disk drive than on multiple drives, thereby reducing read/write overheads.

In some embodiments, configuring a storage array comprising a set of storage drives for data striping includes configuring each storage drive in the set of storage drives into at least two partitions and at least two stripe sizes. More specifically, the at least two partitions includes a first partition having a first partition size and a first stripe size and a second partition have a second partition size and a second stripe size. The first stripe size and the second stripe size are different, whereas the first partition size and the second partition size can be either the same or different.

In some embodiments, the at least two stripe sizes are determined based on file sizes of common file types in historical data traffic received by the storage array. More specifically, the first stripe size and the second stripe size are determined based on file sizes of a first common file type and a second common file type, respectively. Moreover, the first partition size and the second partition size are determined based on statistical composition percentages of the first common file type and the second common file type in the historical data traffic. After the partition, each of the first and second partitions occupies a portion of the storage drive that is consistent with the respective composition percentage of the respective common file type in the historical data traffic. Furthermore, the at least two stripe sizes and the corresponding partition sizes can be dynamically updated by taking into account real time data traffic, and the set of storage drives can be reconfigured based on the updated set of stripe sizes and the corresponding partition sizes.

In some embodiments, configuring a storage array comprising a set of storage drives for data striping is disclosed, by determining at least two different stripe sizes and determining a percentage value of storage space for each of the at least two different stripe sizes. Next, each storage drive is partitioned into a set of partitions according to the determined percentage values and the determined stripe sizes, wherein each partition corresponds to each of the determined stripe sizes and occupies a portion of the storage space on the storage drive that is consistent with the percentage value of the determined stripe size, and each partition in the set of partitions is configured to have a set of data stripes having the corresponding stripe size.

In some embodiments, after configuring the set of storage drives, a file write request is executed on the set of configured storage drives. To do so, a file size associated with the file in the file write request is identified. A target stripe size is then chosen from the at least two different stripe sizes based on the identified file size. Next, a storage drive is identified that includes an available data stripe in a partition of the storage drive corresponding to the target stripe size. The file is then committed (stored) to the available data stripe in the identified storage drive.

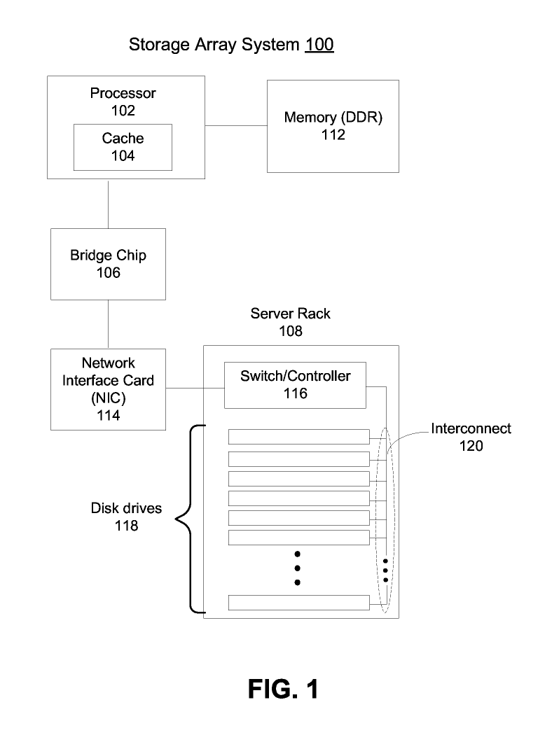

Turning now to the Figures, FIG. 1 illustrates a schematic diagram of an exemplary storage array system 100, such as a RAID. As can be seen in FIG. 1, storage array system 100 includes a processor 102, which is coupled to a memory 112 and to a network interface card (NIC) 114 through bridge chip 106. Memory 112 can include a dynamic random access memory (DRAM) such as a double data rate synchronous DRAM (DDR SDRAM), a static random access memory (SRAM), flash memory, read only memory (ROM), and any other type of memory. Bridge chip 106 can generally include any type of circuitry for coupling components of storage array system 100 together, such as a southbridge.

Processor 102 can include any type of processor, including, but not limited to, a microprocessor, a mainframe computer, a digital signal processor, a personal organizer, a device controller and a computational engine within an appliance, and any other processor now known or later developed. Furthermore, processor 102 can include one or more cores. Processor 102 includes a cache 104 that stores code and data for execution by processor 102. Although FIG. 1 illustrates storage array system 100 with one processor, storage array system 100 can include more than one processor. In a multi-processor configuration, the processors can be located on a single system board or multiple system boards.

Processor 102 communicates with a server rack 108 through bridge chip 106 and NIC 114. More specifically, NIC 114 is coupled to a switch/controller 116, such as a top of rack (ToR) switch/controller, within server rack 108. Server rack 108 further comprises an array of disk drives 118 that are individually coupled to switch/controller 116 through an interconnect 120, such as a peripheral component interconnect express (PCIe) interconnect.

Embodiments can be employed in storage array system 100 to reduce data read/write/update overhead. However, the disclosed techniques can generally operate on any type of storage array system that comprises multiple volumes or multiple drives, and hence is not limited to the specific implementation of storage array system 100 as illustrated in FIG. 1. For example, the disclosed techniques can be applied to a set of solid state drives (SSDs), a set of hybrid drives of HDDs and SSDs, a set of solid state hybrid drives (SSHDs) that incorporate flash memory into a hard drive, a set of optical drives, a combination of the above, among other drive arrays.

Embodiments perform a dynamic data striping on each drive (HDD, SSD, or optical drive) in an array of drives (HDDs, SSDs, or optical drives) in a storage array system, such as a RAID system. Instead of using a constant stripe size to partition a single drive space, each drive is preconfigured with data stripes of at least two different stripe sizes. In some implementations, each drive is partitioned based on a set of distinctive stripe sizes, wherein each of the set of distinctive stripe sizes is assigned with a predetermined percentage of the drive space. More specifically, the set of distinctive stripe sizes can be determined to be consistent with sizes of common file types in the historical data traffic received at the storage array system. For example, one of the stripe sizes used can be 512 KB, which corresponds to 512 KB image files, and another one of the stripe sizes used can be 1 GB, which corresponds to 1 GB video files. As another example, these common file types can include a set of file sizes corresponding to different image scaling levels, e.g., from a thumbnail image to a full-size high definition (HD) image.

The percentage of the drive space assigned to a given stripe size of the set of distinctive stripe sizes can be consistent with the statistical composition percentage of the associated file type in the historical data traffic. For example, if 512 KB image files typically represent ˜15% of the statistical data traffic, 15% of the drive space is assigned to store 512 KB data stripes; and if 1 GB video files typically represent ˜10% of the statistical data traffic, 10% of the drive space is assigned to store 1 GB data stripes.

In some embodiments, prior to configuring a drive space into data stripes, a set of common stripe sizes and the allocation percentages for the set of common stripe sizes are first determined by performing statistical analysis of historical incoming data traffic. Through this data analysis, common file types and associated file sizes can be identified. In some embodiments, one common stripe size can be used to represent a group of similar but non-identical file sizes in the historical incoming data traffic. This common stripe size can be set to be either equal to or greater than the largest file size in the group of similar file sizes. The allocation percentage for a determined common file size can be determined as a ratio of the common file size multiplying the number of such files recorded during an analysis time period to the total data traffic recorded during the same time period. In some embodiments, the set of stripe sizes and the corresponding allocation percentage values can be dynamically updated by taking into account real time data traffic, and the disk drives are subsequently reconfigured based on the updated set of stripe sizes and the corresponding allocation percentage values. To reduce interruption of the read/write operations by such dynamic configuration of the disk drives, the reconfiguration may take place only infrequently.

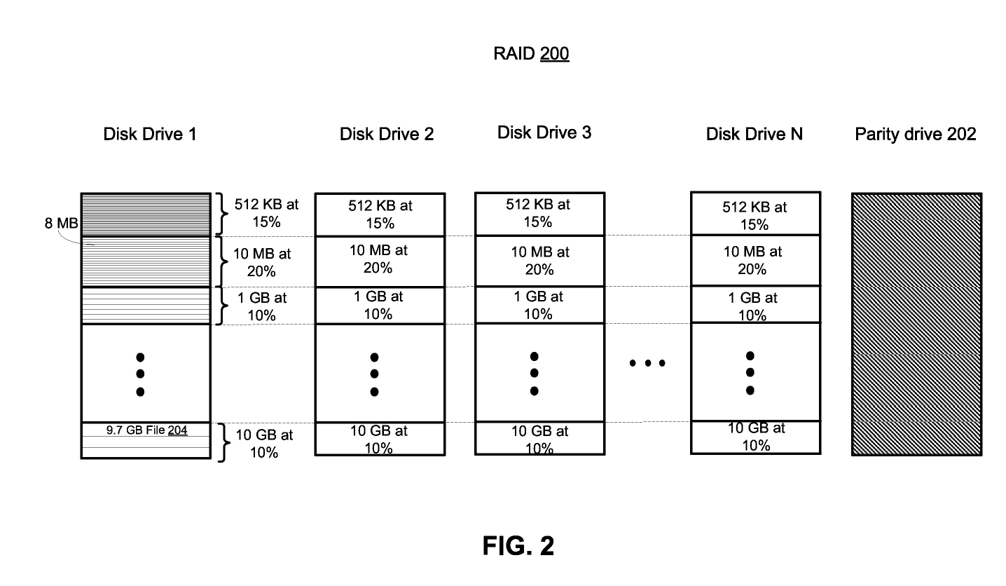

FIG. 2 illustrates an exemplary scheme of dynamic data striping on a set of drives of a RAID 200 system. RAID 200 includes disk drives 1 to N and a parity drive 202. Each of the set of disk drives 1 to N is partitioned into variable sized storage spaces (or “partitions”), and each of the storage spaces or partitions has a partition size and is configured with data stripes of a corresponding stripe size. More specifically, these partitions include 15% allocated to 512 KB data stripes, 20% allocated to 10 MB data stripes, 10% allocated to 1 GB data stripes, 10% allocated to 10 GB data stripes, and so forth. Two different partitions can have the same partition size (for example, the partition with 1 GB data stripes and the one with 10 GB data stripes) or different sizes (for example, the partition with 512 KB data stripes and the one with 10 MB data stripes). Parity drive 202 does not have to be partitioned in the same manner as disk drives 1 to N. While the embodiment of RAID 200 uses a dedicated parity drive to store parity data, the disclosed data striping technique can be applied to RAID systems that do not have a dedicated parity drive but store parity data on a portion of each disk drive in the array.

In some embodiments, when committing files in the incoming data traffic to a disk drive configured based on the proposed data striping scheme, individual files are directly written into regions of the disk allocated for the desired file sizes. More specifically, based on the size of a file in a write request, a controller, such as controller 116, or a processor, such as processor 102, identifies a proper stripe size in the set of distinctive stripe sizes used for drive partition. In some embodiments, the identified stripe size is the one that is greater than but closest to the size of the file to be committed. Once the proper stripe size is identified, the controller looks for an available data stripe associated with the stripe size. If an available data stripe is found, the controller commits the file in one piece into the data stripe. In some embodiments, if no available data stripe exists for the identified stripe size, the controller may look for an available data stripe of the same size on a different drive in RAID 200. For example, if an 8 MB incoming file is to be committed, the controller finds an available 10 MB data stripe in the 10 MB portion of disk drive 1 and writes the 8 MB file into that data stripe.

Note that using the proposed data striping scheme, a set of sequential write requests of similarly sized files and file types can be very efficiently committed to the same partition of a given file size on the same disk, thereby reducing write overheads. For example, a batch of image files can be sequentially committed to the 10 MB data stripes on disk drive 1, while a batch of video files can be sequentially committed to the 1 GB data stripes on disk drive 1.

Alternatively, a set of sequential write requests can be distributed among multiple disk drives so that these write requests can be processed in parallel. For example, a batch of image files of less than 10 MB sizes in the incoming data traffic can be spread across the set of disk drives 1 to N in FIG. 2, so that each of the disk drives independently commits one or more image files into a respective portion of that drive configured with 10 MB data stripes. During this process, each of the image files is written into a single 10 MB data stripe, while no file in the batch of image files has been segmented.

After an incoming file is stored on a single drive, the parity data for the stored file is computed and written onto the parity drive 202. Later, when the stored file is updated, the parity data for the file is also updated. To compute the update for the parity data, the controller only needs to read the updated bits in the updated file stored on the single drive. This is in contrast to conventional data striping techniques where a file is often segmented and stored across multiple drives, and any update to the segmented file would require read operations on the multiple drives in order to recompute the parity data. Hence, embodiments of the present technique facilitate reducing overhead due to file updates.

Furthermore, under some data striping schemes, a large size file in the incoming data traffic, which is traditionally segmented and stored across multiple stripes on multiple drives, can be written into a single data stripe of a comparable stripe size on a single disk drive. For example, FIG. 2 shows that a 9.7 GB file 204 is directly written into a 10 GB data stripe in the partition on disk drive 1 for 10 GB size files. Hence, to update the associated parity data in the parity drive 202 after an update to file 204, the controller only needs to read data from disk drive 1. In contrast, conventional data striping techniques would store file 204 across multiple stripes on multiple drives in RAID 200. This means that, to update the parity data in the parity drive 202 after an update to file 204, the controller would have to read data from multiple drives, thereby increasing operation overhead. Under the exemplary data striping scheme, such parity update overhead can be significantly reduced.

For a similar reason, the proposed data striping scheme facilitates reducing read overhead when a stored file is accessed by a read request. When a file under request is stored on a single drive, reading the file takes place on that single drive. This is in contrast to conventional data striping techniques where a file is often segmented and stored across multiple drives, and hence a read request to the segmented file would require read operations on the multiple drives in order to reconstruct the file. Hence, embodiments of the present technique facilitate reducing read-back overhead.

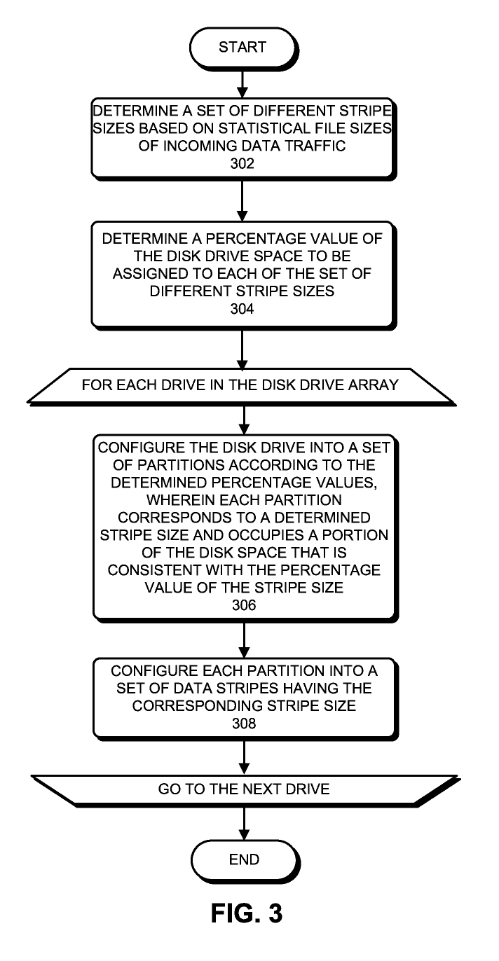

FIG. 3 is a flowchart illustrating an exemplary process of configuring a disk drive array for data striping. During operation, a controller (e.g., controller 116 in FIG. 1) first determines a set of different stripe sizes based on statistical file sizes of incoming data traffic (step 302). For example, each of the set of different stripe sizes is derived based on the size of a common file type in the historical data traffic. In one embodiment, the set of different stripe sizes includes a first stripe size and a second stripe size that is different from the first stripe size. The controller next determines a percentage value of the disk drive space, i.e., a partition size, to be assigned to each of the set of different stripe sizes (step 304). For example, the percentage of the drive space, i.e., the partition size to be assigned to a given stripe size of the set of distinctive stripe sizes can be derived based on a statistical composition percentage of the associated file type in the historical data traffic. Next, the controller configures a target disk drive into a set of partitions according to the determined partitions sizes, wherein each partition corresponds to a determined stripe size and occupies a portion of the disk space that is consistent with the percentage value of the stripe size (step 306). The controller then configures each partition into a set of data stripes having the corresponding stripe size (step 308). Note that two different partitions have different stripe sizes but can have either the same or different partition sizes. The steps of 306-308 are repeated for each disk drive in the disk drive array.

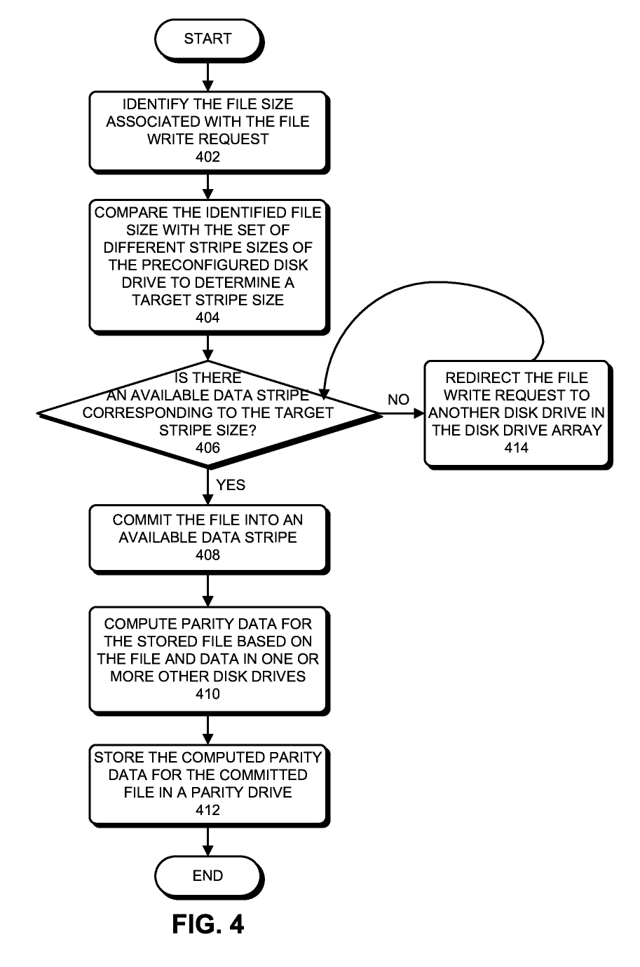

FIG. 4 is a flowchart illustrating an exemplary process of executing a file write request on a preconfigured disk drive resulting from the process of FIG. 3. During operation, a controller (e.g., controller 116 in FIG. 1) first identifies the file size associated with the file write request (step 402). The controller next compares the identified file size with the set of different stripe sizes of the preconfigured disk drive to determine a target stripe size (step 404). For example, the controller can choose a stripe size from the set stripe sizes that is greater than while closest to the identified file size. Next, the controller determines whether there is an available data stripe in the partition of the disk drive corresponding to the target stripe size (step 406). If so, the controller commits the file into an available data stripe (step 408). The controller then computes parity data for the stored file based on the file and data in one or more other disk drives (step 410). The controller next stores the computed parity data for the newly committed file in a parity drive (step 412). If at step 406 the controller fails to find an available data stripe corresponding to the target stripe size, the controller redirects the file write request to another disk drive in the disk drive array (step 414) and subsequently goes back to step 406. Alternatively, the controller can look for an available data stripe in the partition of the disk drive corresponding to another stripe size greater than the target stripe size. Note that when the stored file is updated, the controller updates the corresponding parity data based exclusively on the updated file in the disk drive.

In some embodiments, each disk drive is configured with multiple different stripe sizes based on statistical file sizes of incoming data traffic. For example, a preconfigured disk drive can include a set of different stripe sizes wherein a stripe size is consistent with the size of a common file type in the historical or predicted data traffic. Moreover, the allocation of disk space for each stripe size may be consistent with the composition percentage of the associated file type in the historical or predicted data traffic. As a result, reads/writes of large data files in the storage array predominantly take place on a single disk drive rather than on multiple drives, thereby reducing read/write overheads.

In some embodiments, configuring a storage array comprising a set of storage drives for data striping includes configuring each storage drive in the set of storage drives into at least two partitions and at least two stripe sizes. More specifically, the at least two partitions includes a first partition having a first partition size and a first stripe size and a second partition have a second partition size and a second stripe size. The first stripe size and the second stripe size are different, whereas the first partition size and the second partition size can be either the same or different.

In some embodiments, the at least two stripe sizes are determined based on file sizes of common file types in historical data traffic received by the storage array. More specifically, the first stripe size and the second stripe size are determined based on file sizes of a first common file type and a second common file type, respectively.

In some embodiments, the first partition size and the second partition size are determined based on statistical composition percentages of the first common file type and the second common file type in the historical data traffic. After the partition, each of the first and second partitions occupies a portion of the storage drive that is consistent with the respective composition percentage of the respective common file type in the historical data traffic.

In some embodiments, the at least two stripe sizes and the corresponding partition sizes are dynamically updated by taking into account real time data traffic. Next, the set of storage drives are reconfigured based on the updated set of stripe sizes and the corresponding partition sizes.

In some embodiments, configuring a storage array comprising a set of storage drives for data striping includes determining at least two different stripe sizes and determining a percentage value of storage space for each of the at least two different stripe sizes. Next, for each storage drive in the set of storage drives, the storage drive is configured into a set of partitions according to the determined percentage values and the determined stripe sizes, wherein each partition corresponds to each of the determined stripe sizes and occupies a portion of the storage space on the storage drive that is consistent with the percentage value of the determined stripe size and each partition in the set of partitions is configured into a set of data stripes having the corresponding stripe size.

In some embodiments, the at least two different stripe sizes is determined by using file sizes of common file types in historical data traffic received by the storage array.

In some embodiments, the percentage value of storage space for each of the at least two different stripe sizes is determined by deriving a statistical composition percentage of the associated common file type in the historical data traffic.

In some embodiments, the at least two different stripe sizes and the corresponding percentage values are dynamically updated by taking into account real time data traffic and reconfiguring the set of storage drives based on the updated set of stripe sizes and the corresponding percentage values.

In some embodiments, after configuring the set of storage drives, a file write request is executed on the set of configured storage drives, by identifying a file size associated with the file in the file write request, choosing a target stripe size from the at least two different stripe sizes based on the identified file size, identifying a storage drive in the set of configured storage drives that includes an available data stripe in a partition of the storage drive corresponding to the target stripe size, and committing the file to the available data stripe in the identified storage drive.

In some embodiments, the target stripe size is chosen from the at least two different stripe sizes by choosing a stripe size that is greater than while closest to the identified file size.

In some embodiments, the file write request is executed on the set of configured storage drives does not include segmenting the file.

In some embodiments, the file includes a large video file.

In some embodiments, the set of storage drives includes a RAID. After committing the file to the available data stripe, parity data is computed for the stored file.

In some embodiments, the computed parity data is stored for the stored file in a parity drive.

In some embodiments, if the stored file is updated, the corresponding parity data is updated in the parity drive based exclusively on the updated portion stored file without the need to read the one or more other disk drives in the RAID.

In some embodiments, after configuring the set of storage drives, a set of sequential write requests is received at an interface of the set of storage drives and distributed among the set of storage drives so that the set of sequential write requests can be processed on different drives in parallel.

In some embodiments, the at least two different stripe sizes includes multiple stripe sizes corresponding to a set of image file sizes of different scale levels.

In some embodiments, the set of storage drives includes one or more of a set of hard disk drives (HDDs), a set of solid state drives (SSDs), a set of hybrid drives of HDDs and SSDs, a set of solid state hybrid drives (SSHDs), a set of optical drives; and a combination of the above.

These and other aspects are described in greater detail in the drawings, the description and the claims.

The above-described disk drive configuration and file write request execution processes can be directly controlled by specially designed logic in the disk drive array controller as described above. Alternatively, these processes can be controlled by an Application Program Interface (API) or a system processor, such as processor 102 in storage array system 100.

Implementations of the subject matter and the functional operations described in this patent document can be implemented in various systems, in digital electronic circuitry, or in computer software, firmware, or hardware, including the structures disclosed in this specification and their structural equivalents, or in combinations of one or more of them Implementations of the subject matter described in this specification can be implemented as one or more computer program products, i.e., one or more modules of computer program instructions encoded on a tangible and non-transitory computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document and attached appendices contain many specifics, these should not be construed as limitations on the scope of any invention or of what may be claimed, but rather as descriptions of features that may be specific to particular embodiments of particular inventions. Certain features that are described in this patent document and attached appendices in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document and attached appendices should not be understood as requiring such separation in all embodiments.

Only a few implementations and examples are described, and other implementations, enhancements and variations can be made based on what is described and illustrated in this patent document and attached appendices.

What is claimed is:

1. A method performed by a computing device having a processor and memory for configuring a storage array comprising a set of storage drives for data striping, comprising:
for each storage drive in the set of storage drives:
configuring the storage drive into at least two partitions and at least two stripe sizes, the at least two partitions including:
a first partition having a first partition size and a first stripe size; and
a second partition have a second partition size and a second stripe size, wherein the first stripe size and the second stripe size are different, and wherein the first partition size and the second partition size can be either the same or different.

2. The method of claim 1, wherein the method comprises determining the at least two stripe sizes based on file sizes of common file types in historical data traffic received by the storage array, which includes determining the first stripe size and the second stripe size based on file sizes of a first common file type and a second common file type, respectively.

3. The method of claim 2, wherein the method further comprises determining the first partition size and the second partition size based on statistical composition percentages of the first common file type and the second common file type in the historical data traffic, so that each of the first and second partitions occupies a portion of the storage drive that is consistent with the respective composition percentage of the respective common file type in the historical data traffic.

4. The method of claim 2, wherein the method further comprises:
dynamically updating the at least two stripe sizes and the corresponding partition sizes by taking into account real time data traffic; and
reconfiguring the set of storage drives based on the updated set of stripe sizes and the corresponding partition sizes.

5. The method of claim 1, wherein the method further comprises executing a file write request on the set of configured storage drives by:
identifying a file size associated with the file in the file write request;
choosing a target stripe size from the at least two stripe sizes based on the identified file size;
identifying a storage drive in the set of configured storage drives that includes an available data stripe in a partition of the storage drive corresponding to the target stripe size; and
committing the file to the available data stripe in the identified storage drive.

6. The method of claim 5, wherein choosing the target stripe size from the at least two stripe sizes includes choosing a stripe size that is greater than while closest to the identified file size.

7. The method of claim 5, wherein executing the file write request on the set of configured storage drives does not include segmenting the file.

8. The method of claim 5, wherein the file includes a large video file.

9. The method of claim 5, wherein the set of storage drives includes a redundant array of independent disks (RAID), wherein after committing the file to the available data stripe, the method further comprises computing parity data for the stored file based on the stored file and data in one or more other storage drives in the RAID.

10. The method of claim 9, further comprising storing the computed parity data for the stored file in a parity drive.

11. The method of claim 10, wherein when the stored file is updated, the method further comprises updating the corresponding parity data in the parity drive based exclusively on the updated stored file without the need to read the one or more other storage drives in the RAID.

12. The method of claim 1, wherein the method further comprises:
receiving a set of sequential write requests at an interface of the set of storage drives; and
distributing the set of sequential write requests among the set of storage drives so that the set of sequential write requests can be processed on different drives in parallel.

13. The method of claim 1, wherein the at least two stripe sizes include multiple stripe sizes corresponding to a set of image file sizes of different scale levels.

14. The method of claim 1, wherein the set of storage drives includes one of:
a set of hard disk drives (HDDs);
a set of solid state drives (SSDs);
a set of hybrid drives of HDDs and SSDs;
a set of solid state hybrid drives (SSHDs);
a set of optical drives; and
a combination of the above.

15. A non-transitory computer-readable storage medium storing instructions for improving channel performance in a storage device, comprising:
for each storage drive in the set of storage drives:
configuring the storage drive into at least two partitions and at least two stripe sizes, the at least two partitions including:
a first partition having a first partition size and a first stripe size; and
a second partition have a second partition size and a second stripe size, wherein the first stripe size and the second stripe size are different, and wherein the first partition size and the second partition size can be either the same or different.

16. The non-transitory computer-readable storage medium of claim 15, wherein the method further comprises executing a file write request on the set of configured storage drives by:
identifying a file size associated with the file in the file write request;
choosing a target stripe size from the at least two stripe sizes based on the identified file size;
identifying a storage drive in the set of configured storage drives that includes an available data stripe in a partition of the storage drive corresponding to the target stripe size; and
committing the file to the available data stripe in the identified storage drive.

17. A storage array system, comprising:
a processor;
a memory; and
a set of storage drives coupled to the processor;
wherein the processor is operable to configure the set of storage drives for data striping by:
for each storage drive in the set of storage drives:
configuring the storage drive into at least two partitions and at least two stripe sizes, the at least two partitions including:
a first partition having a first partition size and a first stripe size; and
a second partition have a second partition size and a second stripe size, wherein the first stripe size and the second stripe size are different, and wherein the first partition size and the second partition size can be either the same or different.

18. The storage array system of claim 17, wherein the processor is further operable to execute a file write request on the set of configured storage drives by:
identifying a file size associated with the file in the file write request;
choosing a target stripe size from the at least two stripe sizes based on the identified file size;
identifying a storage drive in the set of configured storage drives that includes an available data stripe in a partition of the storage drive corresponding to the target stripe size; and
committing the file to the available data stripe in the identified storage drive.

19. The storage array system of claim 18, wherein the storage array system is a redundant array of independent disks (RAID) system that further includes a parity drive for storing computed parity data for stored files in the set of configured storage drives.

20. The storage array system of claim 18, wherein the set of storage drives includes one of:
a set of hard disk drives (HDDs);
a set of solid state drives (SSDs);
a set of hybrid drives of HDDs and SSDs;
a set of solid state hybrid drives (SSHDs);
a set of optical drives; and
a combination of the above.
